(19) United States
(12) Patent Application Publication
(10) Pub. No.: US 2025/0240575 A1
(43) Pub. Date: Jul. 24, 2025

(54) MULTI-GAP MAGNETIC MOTOR FOR USE IN LOUDSPEAKERS

(71) Applicant: ALPS ALPINE CO., LTD., TOKYO (JP)

(72) Inventors: Alan Robert Cross, Howell, MI (US); Rory Buszka, Novi, MI (US)

(21) Appl. No.: 18/419,372

(22) Filed: Jan. 22, 2024

(51) Int. Cl. H04R 9/02; H04R 7/16; H04R 9/06

(52) U.S. Cl. CPC H04R 9/025; H04R 9/06; H04R 7/16

(57) ABSTRACT

A magnetic circuit assembly may be used in a loudspeaker. The magnetic circuit can include first and second plates, a magnet, and a yoke. The first plate can have a distal surface and a proximal surface. The second plate can have a distal surface and a proximal surface opposite the distal surface. The distal surface of the second plate may be disposed along the proximal surface of the first plate. At least one of the first or the second plates can have a first radial portion with a smaller axial dimension than a second radial portion. The magnet can have a distal surface and a proximal surface such that the distal surface of the magnet is disposed along the proximal surface of the second plate. The yoke can form first and second magnetic circuit gaps radially between the yoke and the first and second plates, respectively.

### BACKGROUND

### Field

This disclosure relates generally to loudspeakers and to magnetic circuits for loudspeakers.

### Description of Related Art

Loudspeakers provide listeners quality sound audible from a distance and through various media. Various configurations of loudspeakers have been developed over the years. Current loudspeakers have some functionality with regard to developing a magnetic circuit and converting electrical energy into sound waves. Various magnetic circuit assemblies have been developed to channel magnetic fields in various electrical devices, including loudspeakers. However, certain features are lacking and multiple problems exist in the art for which this application provides solutions.

### SUMMARY

Example embodiments described herein have innovative features, no single one of which is indispensable or solely responsible for their desirable attributes. Without limiting the scope of the claims, some of the advantageous features will now be summarized.

In some embodiments, a magnetic circuit assembly may be used in a loudspeaker. The magnetic circuit may include first and second plates, a magnet, and a yoke. The first plate can have a distal surface and a proximal surface. The second plate can have a distal surface and a proximal surface opposite the distal surface. The distal surface of the second plate may be disposed along the proximal surface of the first plate. At least one of the first or the second plates can have a first radial portion with a smaller axial dimension than a second radial portion. The magnet can have a distal surface and a proximal surface such that the distal surface of the magnet is disposed along the proximal surface of the second plate. The yoke can form first and second magnetic circuit gaps radially between the yoke and the first and second plates, respectively.

### BRIEF DESCRIPTION OF THE DRAWINGS

The following drawings and the associated descriptions are provided to illustrate embodiments of the present disclosure and do not limit the scope of the claims.

FIG. 1 schematically shows a cross-section of an example loudspeaker 100 design.

FIG. 2 shows a schematic of a cross section of an example embodiment of a ring magnet design of a loudspeaker, according to some embodiments.

FIG. 3 schematically shows a cross-section of an example loudspeaker with a core magnet design, according to some embodiments, according to some embodiments.

FIG. 4 shows a schematic of a cross section of an example embodiment of a core magnet design of a loudspeaker, according to some embodiments.

FIG. 5 shows a schematic of a cross-section of a magnetic circuit assembly that can be used in a loudspeaker, according to some embodiments.

FIG. 6 shows a schematic of a cross-section of an example magnetic circuit assembly, according to some embodiments.

FIG. 7 shows another example magnetic circuit assembly, according to some embodiments, along with modeled magnetic field lines.

FIG. 8 shows values for magnetic flux (B) and the product BL over a distance from a geometric center of a voice coil for two designs.

FIG. 9 shows a schematic of a cross section of another example embodiment of a ring magnet design of a loudspeaker, according to some embodiments.

FIG. 10 shows a schematic of a cross section of an example embodiment of a ring magnet design of a loudspeaker, according to some embodiments.

These and other features will now be described with reference to the drawings summarized above. The drawings and the associated descriptions are provided to illustrate embodiments and not to limit the scope of any claim. Throughout the drawings, reference numbers may be reused to indicate correspondence between referenced elements. In addition, where applicable, the first one or two digits of a reference numeral for an element can frequently indicate the figure number in which the element first appears.

### DETAILED DESCRIPTION

Although certain embodiments and examples are disclosed below, inventive subject matter extends beyond the specifically disclosed embodiments to other alternative embodiments and/or uses and to modifications and equivalents thereof. Thus, the scope of the claims appended hereto is not limited by any of the particular embodiments described below. For example, in any method or process disclosed herein, the acts or operations of the method or process may be performed in any suitable sequence and are not necessarily limited to any particular disclosed sequence. Various operations may be described as multiple discrete operations in turn, in a manner that may be helpful in understanding certain embodiments; however, the order of description should not be construed to imply that these operations are order dependent. Additionally, the structures, systems, and/or devices described herein may be embodied as integrated components or as separate components. For purposes of comparing various embodiments, certain aspects and advantages of these embodiments are described. Not necessarily all such aspects or advantages are achieved by any particular embodiment. Thus, for example, various embodiments may be carried out in a manner that achieves or optimizes one advantage or group of advantages as taught herein without necessarily achieving other aspects or advantages as may also be taught or suggested herein.

Existing magnetic circuits are sufficient for certain purposes. However, a need exists to increase the magnetic performance that previous designs, even previous dual gap designs, can allow. Design goals of a magnetic circuit may include reduced distortion and improved control of transducer motion over a wide range of voice coil position. Described herein are example designs that can allow for improved magnetic circuit performance by, for example, combining multi-gap (e.g., dual gap) technology with a multi-magnet (e.g., dual magnet) topology. Designs described herein can allow creation of an extremely strong magnetic gap compared to previous known multiple-gap designs, thus providing a high efficiency transducer design. Certain designs allow a reduced depth of motor by using a specific double gap design. For example, a standard gap design may have close to 25 mm more depth with a similar performance to meet the same linear force applied to the voice coil (“Xmax”) excursion desired. Certain designs described herein can help reduce inductance of the voice coil relative to those using a standard one gap motor design. Optimized dual-gap designs, for example, can allow creation of an assembly with less tooling required, since certain components (described below) may be used multiple times (e.g., twice) within a single assembly, such as by flipping the component by 180 degrees.

A reduced motor depth can reduce a height of a voice coil (often referred to as “wind width” (WW)) while still achieving a BL gap width to meet a target Xmax. This can allow achievement of a strong low frequency (LF) performance with low total harmonic distortion (THD). Additionally or alternatively, this may also allow a reduction in internal inductance of the coil, thus lowering distortion and improving high frequency (HF) extension. The output of certain speaker embodiments described herein may be as great as 117 dB over a wide operating frequency range (e.g., 70-5,000 Hz) in a relatively small form factor. Thus, motor topologies described herein can achieve a high motor force in a small form factor, permitting high acoustic output. Additionally or alternatively, the topologies described can allow for reduced WW, thus lowering mass and inductance, which can be two main inhibitors in achieving high efficiency of transducer efficiency.

Additionally or alternatively, the topologies described herein may provide improved low frequency performance. The topologies described can achieve a high Xmax in a small form factor. The depth saved can give the transducer excursion clearance to move so it can produce the target low frequency sound output level. Additionally or alternatively, the designs herein can have improved heat dissipation due to clear heat paths out of the motor assembly.

Described herein are systems for loudspeakers and magnetic circuit assemblies. It will be understood that although the description herein is in the context of loudspeakers and magnetic circuits, one or more features of the present disclosure can also be implemented in other electrical devices, such as generators, electromagnets, electric motors, linear actuators, vibration transducers, and the like. Some embodiments of the methodologies and related systems disclosed herein can be used with various loudspeaker designs.

Unless explicitly indicated otherwise, terms as used herein will be understood to imply their customary and ordinary meaning within the field of the art.

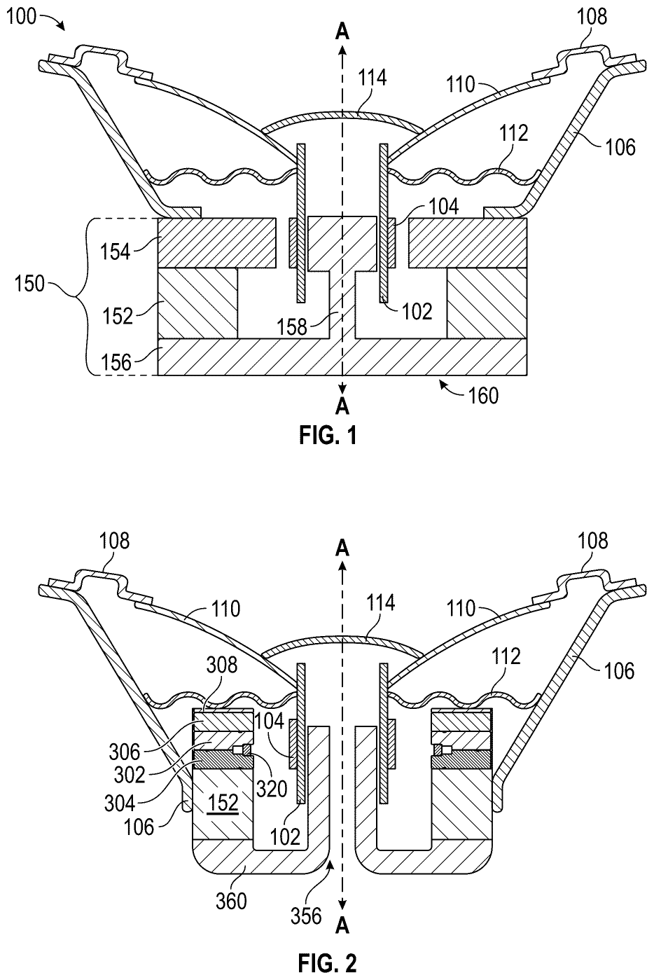

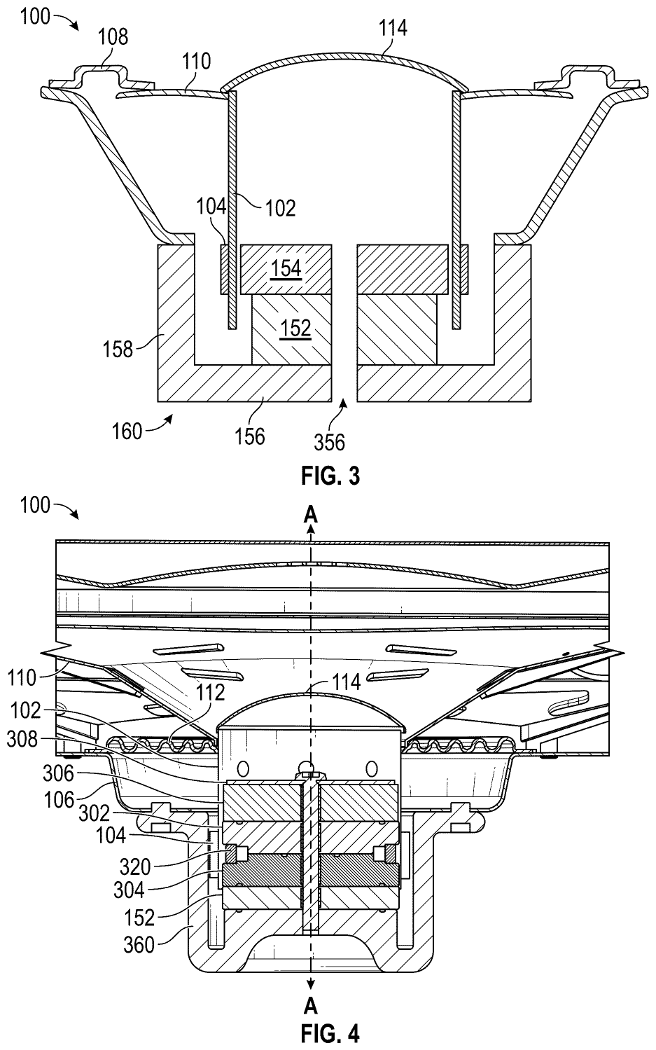

FIG. 1 schematically shows a cross-section of a loudspeaker 100 with a ring magnet design. A loudspeaker 100 may include one or more components described herein. However, because not every element of the loudspeaker 100 is required in every embodiment, no single element should be viewed as indispensable to the loudspeaker 100. The loudspeaker 100 shown in FIG. 1 represents a circular magnet (ring or annular magnet) design. However, core magnet designs (slug or internal magnet type) as well as obround or rectangular magnet designs may also be implemented using magnetic circuit designs and configurations substantially similar to those described herein with modest adjustments. An example of such an embodiment is provided by FIG. 3. Minor differences between a design in FIG. 1 and one in FIG. 3 would be clear to one of ordinary skill in the art and are omitted in favor of clarity and brevity.

The loudspeaker 100 is shown with a central axis A about which the loudspeaker 100 has approximate radial symmetry. Accordingly, FIG. 1 represents elements that may appear to be duplicated but may be representative of a common element disposed about an axis. In some designs, however, multiple elements may be used for a single feature.

The loudspeaker 100 includes a frame 106. In some embodiments, the frame 106 may be called a basket or a housing. At or near a first end of the frame 106, the frame may be attached to a front plate assembly 154 of a magnetic circuit assembly 150. The front plate assembly 154 may comprise a receiving portion (not shown) for receiving the attachment of the frame 106. The frame 106 may be adhered (e.g., glued), bonded (e.g., soldered, welded), or otherwise affixed in another way to the front plate assembly 154. For example, in some embodiments a pressure fit configuration may be used. In some designs, one or more screws, rivets, or mechanical fasteners may be used to attach the frame 106 to the front plate assembly 154. In some embodiments, the frame 106 may be attached to a resilient connector 108 at or near a second end of the frame. In some embodiments, the frame 106 may be attached directly to a diaphragm 110.

In some embodiments, the front plate assembly 154 can include one or more plates and/or one or more magnets. For example, as shown in FIG. 2, the front plate assembly 154 can include a first plate 302, a second plate 304, a second magnet 306, and/or a top cap 308. Additionally or alternatively, the front plate assembly 154 can include a shorting ring 320. These features are described in more detail below. Accordingly, in some embodiments, the frame 106 may be coupled to the second magnet 306, the top cap 308, and/or a different element described herein.

The frame 106 may comprise a thin plate of a rigid material (e.g., steel, plastic, synthetic resin, wood). In some embodiments, the frame 106 comprises a nonmagnetic material (e.g., aluminum or aluminum alloy), however ferromagnetic materials such as steel may also be used. The frame 106 may also attach to a damper 112. The frame 106 may exhibit radial symmetry or approximate radial symmetry about the central axis A.

The resilient connector 108 may be called a surround, an elastic edge, or an outer suspension. The resilient connector 108 may be bonded to the frame 106. The resilient connector 108 may be attached to the frame 106 using an attachment device. For example, in some designs a gasket can be used. In some embodiments, the resilient connector 108 comprises a thin sheet of rigid or resilient material. Because it comprises a sufficiently thin material, even if the material is rigid, the resilient connector 108 can support minor perturbations between the frame 106 and the diaphragm 110.

The loudspeaker 100 may also include a damper 112. The damper 112 may also be referred to as a spider or inner suspension in some embodiments, though other terms may be used. A first end of the damper 112 may be connected to the frame 106 closer to the first end than the second end of the frame 106. A second of the damper 112 may be attached to a bobbin 102. The damper 112 may support the bobbin 102 to allow the bobbin 102 to vibrate while preventing or reducing contact of either the bobbin 102 or coil 104 with parts of the magnetic circuit assembly 150 (e.g., the front plate assembly 154, pole piece 158). The bobbin 102 may be attached to the damper 112 in a number of different ways (e.g., bonded, adhered). In some embodiments, the damper 112 may comprise a resin-containing cloth. The damper 112 may comprise a resin plate that forms a ring. As shown from the side, as in FIG. 1, the damper 112 may be radially corrugated. The radially corrugation may be formed concentric with the central axis A.

A loudspeaker 100 may generally include a diaphragm 110. As the diaphragm vibrates, sound may be produced and/or amplified. The diaphragm 110 may also be referred to as a cone (e.g., sound cone). Generally, the diaphragm 110 comprises a hole in the center of the diaphragm 110, thus forming a ring, however a flat plate shape may also be used. The diaphragm 110 may comprise a resilient material (e.g., resin, cloth, plastic, paper, fibers, etc.). In many embodiments, the diaphragm 110 is radially symmetrical about the central axis A. In such embodiments, sound can be concentrated in a direction along the central axis A. The diaphragm 110 (e.g., at an inner periphery of the diaphragm 110) may be attached to or near a first end of the bobbin 102. The resilient connector 108 may be attached (e.g., bonded, adhered) to an outer periphery of the diaphragm 110. Thus, the diaphragm 110 can be engaged with the coil 104.

Near the inner periphery of the diaphragm 110, a cap 114 may be attached. The cap 114 may be referred to as a dome, a dust cap, or a dust cover in various embodiments. The cap 114 can be centered on the central axis A. In some embodiments, the cap 114 may be coaxial with the pole piece 158 and/or yoke assembly 160. The cap 114 may “close” the bobbin 102. As shown, in some designs the cap 114 has a dome shape. A cap 114 may not be necessary if its geometry is formed into the diaphragm 110 or if a flat plate is used.

In some embodiments, the loudspeaker 100 includes a bobbin 102. In some embodiments, the bobbin 102 may be referred to as a former or coil former. The bobbin 102 may form a ring surrounding the central axis A. In some designs, the bobbin 102 extends axially at least to an axial position of the front plate assembly 154. Accordingly, the bobbin 102 may form a cylindrical shape. However, the bobbin 102 may extend further, as shown in FIG. 1. Other alternatives are possible. As shown, the diaphragm 110 and/or the damper 112 may be attached (e.g., bonded, adhered) to or near a first axial end of the bobbin 102. Non-round bobbins are also possible, having a shape that is commonly obround or rectangular as required by the configuration of the loudspeaker.

The bobbin 102 may be configured to support a coil 104. The coil 104 may be referred to as a voice coil in some embodiments. The coil 104 may be comprised of a conductor which is wrapped through one or more complete turns having a closed shape around the bobbin. The coil 104 may be attached or otherwise secured to the bobbin 102 using a number of means (e.g., adhered, bonded). The coil 104 can be configured to receive an electric current therethrough. The electric current creates a magnetic field that interacts with a magnetic field produced by the magnet 152. For example, the interaction may cause the coil 104 to translate axially back and forth. This interaction can cause the coil 104, and thereby the bobbin 102, to vibrate axially along the central axis A and/or radially. The vibration can be transferred to, for example, the diaphragm 110 to produce a target sound based on an electrical input.

The coil 104 may comprise a series of windings of a conductive material (e.g., metal) wrapped around the bobbin 102. The windings may have a radial thickness extending radially from the bobbin 102. The radial thickness may be smaller than a gap (not labeled in FIG. 1) between the front plate assembly 154 and the pole piece 158. For example, the coil 104 may be disposed between an outer radius of the pole piece 158 and an inner radius of the front plate assembly 154. In some designs, the coil 104 comprises the same number of windings (e.g., turns) of the conductive material axially along the portion of the bobbin 102 to which it is secured. Having such a homogeneous distribution of windings can create a more uniform magnetic field along the height (e.g., measured axially) of the coil 104. The height of the coil 104 may be less than a corresponding height of the front plate assembly 154 and/or portion of the pole piece 158.

The loudspeaker 100 generally includes a magnetic circuit assembly 150. Generally, the magnetic circuit assembly 150 may include a front plate assembly 154, a magnet 152, and a yoke assembly 160. The yoke assembly 160 may comprise a back plate 156 and/or a pole piece 158. As in the other elements described with reference to FIG. 1, the elements of the magnetic circuit assembly 150 are depicted only schematically. For example, the front plate assembly 154 may comprise one or more elements. For example, as noted above, the front plate assembly 154 may include a first plate 302, a second plate 304, a second magnet 306, and/or other elements. Similarly, the magnet 152, back plate 156, and/or pole piece 158 may comprise one or more elements.

In some embodiments, the front plate assembly 154 is axially adjacent the magnet 152 and can have a central axis in common with the central axis A of the magnet 152. However, other arrangements are possible. The front plate assembly 154 may be secured to the magnet 152. For example, the front plate assembly 154 may be attached using an adhesive (e.g., glue) or a bonding technique. The region where the front plate assembly 154 is attached to the magnet 152 can be called an interface layer. It may be advantageous to reduce a distance (e.g., any gaps) between the front plate assembly 154 and the magnet 152, such as a thickness of the interface layer, which can comprise glue or other connection material. Various embodiments of the front plate assembly 154 are described in more detail below.

A magnet 152 may be used to create a magnetic flux across a gap between the front plate assembly 154 and the pole piece 158. The magnet 152 may be a permanent magnet (e.g., comprising neodymium and/or a ferrous material, such as ferrite) or a temporary magnet (e.g., electromagnet). For example, a ring magnet design may include ferrite and/or a core magnet design may include neodymium. Other variations are possible, including variations using other types of magnetic materials. In some embodiments the first magnet 152 can be configured to generate a higher magnetic flux than ferrite. For example, the first magnet 152 may include a rare earth material, such as neodymium and/or other rare earth magnetic materials. In certain embodiments, a magnetic circuit includes one or more magnets having a remanence (Br) that is from about two times to about eight times greater than ferrite magnet remanence. In some embodiments, a magnetic circuit includes one or more magnets having an energy product (BH max) that is from about 2 times to about 20 times greater than ferrite magnet energy product. For the same size, a neodymium magnet produces a stronger magnetic field and a higher magnetic flux than a ferrite magnet. Neodymium magnets also have a higher magnetic saturation point compared to ferrite magnets, resulting in a higher magnetic flux. Neodymium magnets are also sometimes called NdFeB magnets.

The magnet 152 may be disposed between the front plate assembly 154 and the back plate 156 of the yoke assembly 160. The magnet 152 may be oriented to produce a magnetic field axially through first and second surfaces of the magnet, the first surface being opposite the second surface. For example, the poles of the magnet may be oriented parallel to axis A. In some designs, the second surface has an inner radial region and an outer radial region, described in more detail below.

The yoke assembly 160 (e.g., the back plate 156) may be secured (e.g., adhered) to the magnet 152 on a surface of the magnet 152 opposite to the surface to which the front plate assembly 154 is secured. The yoke assembly 160 may be attached using an adhesive (e.g., glue), a bonding technique, or any other suitable technique. It may be advantageous to reduce a distance (e.g., gaps and/or an interface layer) between the front plate assembly 154 and the magnet 152, such as any caused by gluing or other attachment means. Various embodiments of the yoke assembly 160 (including the back plate 156 and/or pole piece 158) are described in more detail below.

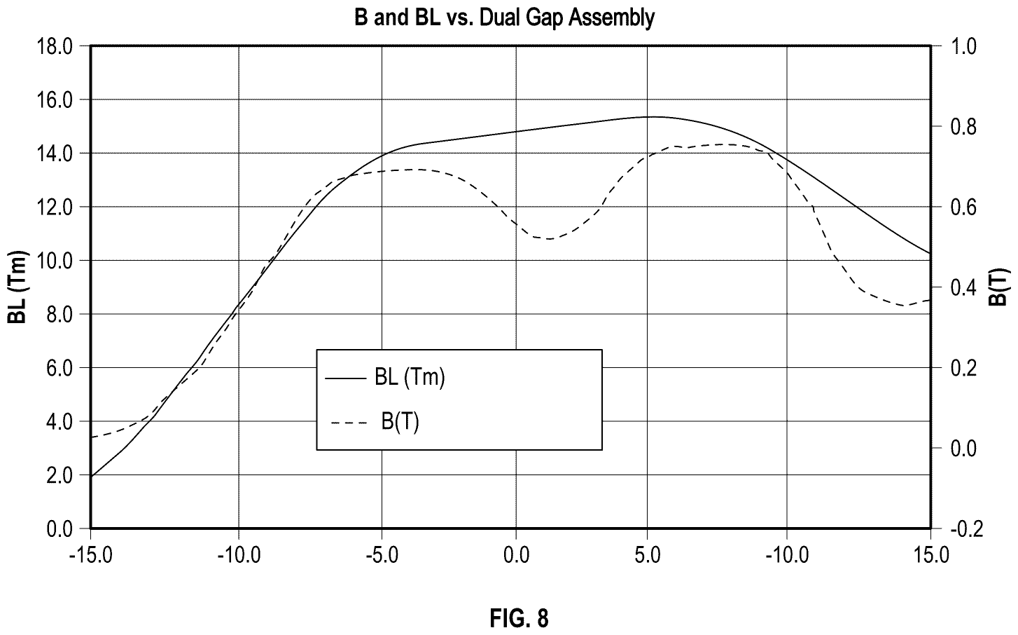

FIG. 2 shows a schematic of a cross section of an example embodiment of a ring magnet design of a loudspeaker 100. Commonly numbered elements may include functionality of the numbers described elsewhere herein. The loudspeaker 100 may include a magnetic circuit assembly that includes a magnet 152; a front plate assembly that comprises a first plate 302 and a second plate 304; and a yoke 360. The first plate 302 and/or second plate 304 may be manufactured (e.g., forged) separately and attached to the magnet 152. The frame 106 may be attached to the magnet 152 or other part of the front plate assembly. In some embodiments, the frame 106 can be attached radially adjacent the back plate 156 and/or on an underside of the back plate 156. This may help dissipate heat from the loudspeaker 100. As shown in FIG. 2, the coil 104 may be disposed between the bobbin 102 and the front plate assembly. A height (measured axially) of the coil 104 may be less than a height of the front plate assembly. This can provide a greater proportion of the coil 104 that is within a target region of magnetic flux. For example, such a region be one having a relatively consistent magnetic flux across the region (see also FIG. 8 below).

The second plate 304 may be disposed adjacent the magnet 152. Additionally or alternatively, the first plate 302 may be disposed adjacent the first magnet 152. A distance between the second plate 304 (and/or the first plate 302) and the magnet 152 may be less than 0.5 mm. For example, this distance may be about 0.1 mm. The distance may comprise a glue gap between the respective components. In some embodiments, a cross section of the first plate 302 forms an L-shape. The first plate 302 may comprise a material with high magnetic permeability, such as iron or steel. In some embodiments, a cross section of the second plate 304 forms an L-shape. In some embodiments the first plate 302 and the second plate 304 may be substantially identical, although they may be oriented differently from one another. For example, the first plate 302 and the second plate 304 may be oriented in mirror image from one another (e.g., relative to a horizontal plane). This may form a vertical gap between the first plate 302 and the second plate 304. In some embodiments the vertical gap may be nearer to the coil 104 than portions of the first plate 302 and second plate 304 that are disposed along one another. For example, as shown in FIG. 2, the vertical gap may be disposed between radially inward portions of the first plate 302 and the second plate 304. However, in other embodiments (e.g., see FIG. 3), the vertical gap may be disposed between radially outward portions of the first plate 302 and the second plate 304. As shown in FIG. 2, at least a portion of the first plate 302 may be disposed between the magnet 152 and the second plate 304. The first plate 302 and/or the second plate 304 may comprise a metal, such as steel (e.g., a low carbon steel), iron, and/or composite materials (e.g., metamaterials that may have a higher magnetic permeability than metals or metal alloys).

As shown in FIG. 2, at least one of the first plate 302 and/or the second plate 304 may have a first radial portion with a smaller axial dimension than a second radial portion. The first radial portion (having the smaller axial dimension) may be disposed radially inward of the second radial portion, relative to axis A, such as shown in FIG. 2. However, as shown in FIG. 3, in some embodiments the first radial portion may be disposed radially outward of the second radial portion, relative to axis A.

As shown in FIG. 2, a distal surface of the second magnet 306 may be disposed distally beyond a most distal surface of the yoke 360. As used herein, “distal” may refer to a surface nearest elements of the loudspeaker 100 from which the speaker sound emanates (e.g., the resilient connector 108, the diaphragm 110, the cap 114). The “distal” end of the speaker may be referred to as the “top” of the speaker. By contrast, the “proximal” end of the speaker may refer generally to the side of the speaker with the yoke 360, such as a back plate of the yoke 360. The proximal end of the speaker may correspond to the “bottom” of the speaker. Thus, a second magnet 306 may have a surface disposed higher or above a highest surface of the yoke 360. This arrangement may promote magnetic flux to be passed through the open air above the second magnet 306 and/or through various distal elements of the loudspeaker 100 (e.g., the frame 106, the damper 112, the diaphragm 110). Thus, the second magnet 306 may be disposed relative to the yoke 360 such that the frame 106 is configured to conduct magnetic field flux from the second magnet 306. Additionally or alternatively, a distal-most surface of the first plate 302 may be disposed more proximal than (e.g., below) a distal-most surface of the yoke 360. This arrangement may further promote the flow of magnet flux through the frame 106. However, in some embodiments the distal-most surface of the first plate 302 may be more distal than (e.g., above) the distal-most surface of the yoke 360. The term “shellpot” can be used interchangeably with “yoke” or can be considered a type of yoke. A shellpot can encase the magnet and may form a magnetic structure that resembles a pot or shell-like enclosure, which can help focus the magnetic field in the desired area. The second magnet 306 may include one or more properties of the first magnet 152 described above. For example, the second magnet 306 may include a rare earth material, such as neodymium and/or other rare earth magnetic materials. The second magnet 306 can have a proximal surface disposed along a distal surface of the first plate 302.

The top cap 308 may be disposed along a distal surface of the second magnet 306. The top cap 308 may promote better coupling together of the second magnet 306, the first plate 302, and the second plate 304. For example, a coupling element (e.g., screw, nail, rivet, or other mechanical fastener) may pass through these elements and the top cap 308 can couple to the end of the coupling element to provide a rigid assembly. In some embodiments the top cap 308 is the upper-most element of the front plate assembly (e.g., the front plate assembly 154). Additional details related to the front plate assembly shown in FIG. 2 are discussed with regard to FIG. 6 below.

The loudspeaker 100 may further include a shorting ring 320. The shorting ring 320 may be disposed between the bobbin 102 and the yoke 360. Additional details about the shorting ring 320 are discussed below. The yoke 360 can be solid along the central axis A. Alternatively, as shown in FIG. 2, the yoke 360 may include a vent 356 therein. The vent 356 may help provide cooling for the loudspeaker 100 and/or magnetic circuit assembly.

As noted above, a core magnet design may be used instead of a ring magnet design. Many of the components used in the core magnet design are similar or the same as those described with regard to the ring magnet designs. FIG. 3 schematically shows a cross-section of a loudspeaker 100 with a core magnet design. As shown, the coil 104 may be disposed between the pole piece 158 and the bobbin 102 and/or the front plate assembly 154. The bobbin 102 may be disposed between the coil 104 and the front plate assembly 154. As shown, the pole piece 158 may be disposed radially outward from the magnet 152 and/or front plate assembly 154. The loudspeaker 100 may include a vent 356. In some embodiments, a loudspeaker 100 with a core magnet design may include a shorting ring (not shown). One or more shorting rings may be disposed near the pole piece 158 and/or the front plate assembly 154, such as between the pole piece 158 and the coil 104. Other variations are also possible, as described herein.

FIG. 4 shows a schematic of a cross section of an example embodiment of a core magnet design of a loudspeaker 100. The radial orientation of the magnetic circuit assembly is essentially opposite of the orientation of the assembly in FIG. 2, relative to the central axis A. For example, an axial gap between the first plate 302 and the second plate 304 may be disposed at radially outward portions of the first plate 302 and the second plate 304, relative to the axis A, in some embodiments. The shorting ring 320 may be disposed as shown within the axial gap, according to some embodiments. As shown, in some embodiments the coil 104 is disposed between the yoke 360 and the bobbin 102. A height (measured axially) of the coil 104 may be smaller than a height of the second plate 304. Additional details of the magnetic circuit assembly and other elements of the loudspeaker 100 are provided below (for example, with regard to FIGS. 1 and 6). As shown in FIG. 4, the loudspeaker 100 may include no vent. Additionally or alternatively, one or more coupling elements (e.g., a screw, nail, or other mechanical fastener) may be used to maintain physical proximity of a plurality of the magnetic circuit elements together, such as the front plate assembly. As shown, a central screw is used to couple the top cap 308, the second magnet 306, the first plate 302, the second plate 304, the first magnet 152, and the yoke 360 together. Other arrangements are possible.

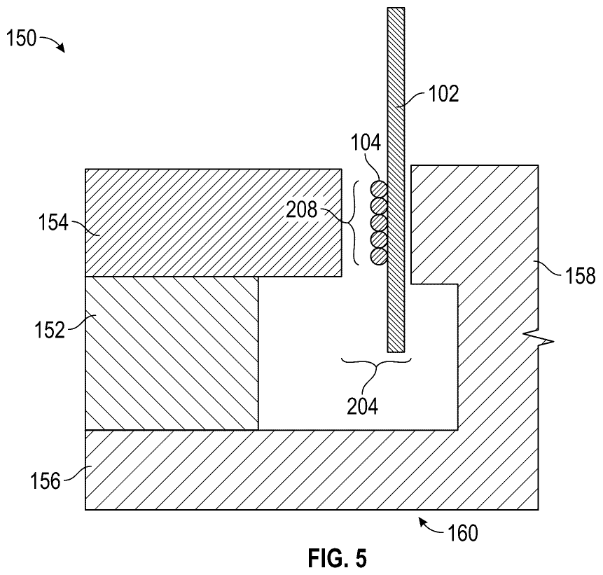

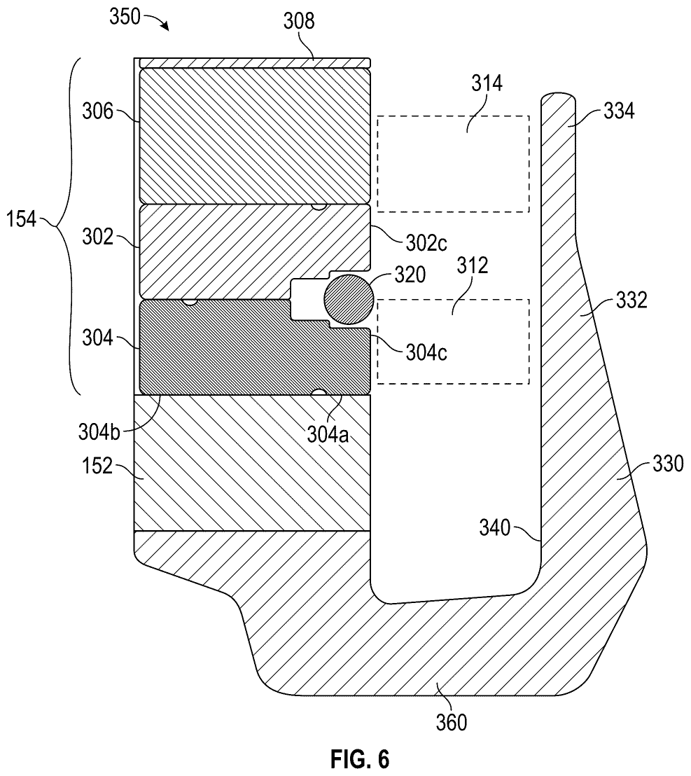

FIG. 5 shows a schematic of a cross-section of a portion of a magnetic circuit assembly 150 that may, for example, be used in a loudspeaker. In some embodiments, a pole piece 158 may be used to complete a magnetic circuit within the magnetic circuit assembly 150. In some designs, the pole piece 158 includes one or more vents (e.g., hollow portion running axially through the pole piece 158), not shown in FIG. 1. Such vents may be beneficial in cooling the magnetic circuit assembly 150 and/or loudspeaker 100. The one or more vents could be disposed axially below the coil 104 (e.g., between the magnet 152 and the pole piece 158). Accordingly, one or more vents may be disposed radially from the axis A. The loudspeaker 100 can include a plurality of vents, such as 3, 4, 6, or 8. Where a plurality of vents is included, they may be positioned in radial symmetry. The one or more vents can be used to improve cooling, reduce the mechanical resistance, and/or reduce air noise. A vent disposed about the axis A may be more effective at reducing mechanical resistance while peripheral vents may be more effective at cooling the magnetic circuit (e.g., especially the coil 104). Such peripheral vents can promote cooling air over the coil.

The pole piece 158 may be shaped to accommodate different needs of various embodiments. In some embodiments, the pole piece 158 may be tapered at one end (e.g., front, back). This may allow for reduced manufacturing requirements, to allow for proper sizing and weight requirements for a loudspeaker, or to optimize an amount of magnetic flux through the pole piece 158, for example. As shown in FIG. 5, some embodiments include a T-shape pole piece 158 that may be useful in optimizing a target width (e.g., radial width) of a gap 204. However, in other embodiments, the pole piece 158 does not include a T-shape. In some designs, the pole piece 158 may include a surface opposite the magnet 152 that is generally smooth and/or flat. The surface may run parallel to the axis A, for example. In some embodiments, the surface represents a radial boundary of the pole piece 158. The pole piece 158 may consist of a single pole element (as shown in FIGS. 1-2), though in some embodiments the pole piece 158 comprises two or more elements.

The yoke assembly 160 provides a portion of the magnetic circuit of the magnetic circuit assembly 150. In some designs, the yoke assembly 160 includes two separate elements, such as a distinct back plate 156 and pole piece 158. For example, as shown in FIG. 10, the yoke 360 may include a first magnetic yoke 358 and a second magnetic yoke 359 that are distinct from each other. In some embodiments the first magnetic yoke 358 and the second magnetic yoke 359 may be fused together or be a unitary element. As in FIG. 1, the back plate 156 and the pole piece 158 may be an example of a unitary yoke assembly 160. However, the yoke assembly 160 may consist of a single piece where the back plate 156 and pole piece 158 form a continuous piece (as shown, for example, in FIGS. 1-2). The yoke assembly 160 may include a surface that is perpendicular to the axis A.

The magnetic circuit assembly 150 may be configured to generate a magnetic circuit through the front plate assembly 154, the yoke assembly 160, and across the gap 204. The magnetic circuit assembly 150 may be configured to pass between about 80 and 99 percent of the magnetic flux within the magnetic circuit across the gap 204. This may be particularly true for core magnet configurations. In some embodiments (e.g., a ring magnet design), the flux across the gap 204 may be between 50 and 80 percent of a total flux. In some embodiments, the flux may be about 70 percent of a total flux. Within the gap 204 may be one or more elements of the magnetic circuit assembly 150. For example, the bobbin 102 and/or coil 104 may be disposed within the gap 204. As the magnetic flux interacts with the coil 104, the coil 104 vibrates and may produce a sound, for example, from the loudspeaker 100.

As shown, in some embodiments (e.g., in ring magnet designs), the windings of the coil 104 are disposed on a side of the bobbin 102 opposite the pole piece 158. However, in other embodiments (e.g., core magnet designs), the windings of the coil 104 may be on a side of the bobbin 102 opposite the magnet 152, or on both sides of the bobbin. A height 208 of the coil 104 may be defined along the axis A (e.g., as shown in FIG. 5). In some embodiments, the height 208 of the coil 104 may be approximately equal to a height of the front plate assembly 154 and/or a T-shape portion of the yoke assembly 160 (if available). In some designs, the height 208 of the coil 104 is smaller or greater than the height of the front plate assembly 154. For example, the height 208 of the coil 104 may be about half of a height of the front plate assembly 154. In some embodiments the height 208 may be between about 0.1 mm and 150 mm. For example, in some embodiments, the height 208 may be between about 10 mm and 30 mm. This range can provide sufficiently small form factor while still achieving a significant volume. In some examples, the height 208 of the coil 104 is about 12 mm. This may be about half of the height of a voice coil in other models of speakers that can produce the same volume output. For larger speakers, larger heights 208 are possible. The height 208 of the coil 104 may be referred to as “wind width” or WW. A width (e.g., radially) of the coil 104 may be between about 55 percent and 90 percent of the width of the gap 204. In some embodiments, the width of the coil 104 is about 71 percent or about 75 percent of the width of the gap 204. It may be advantageous to reduce the width of the gap 204. For example, reducing the width of the gap 204 may improve a performance of the loudspeaker 100, for example, by improving integrity of the sound relative to an electrical input. The gap 204 may be between about 1 mm and 12 mm wide. In some embodiments, the gap 204 has a width of about 3.5 mm. In some embodiments, the width is about 2 mm. In some embodiments other combinations of gap height and wind width may be considered as being necessary to produce a certain range of linear excursion of the speaker within a certain tolerance for BL product variation through the coil stroke. BL Product is the force factor of the speaker, corresponding approximately to the product of the length of conductor (L) disposed within a magnetic field, and the magnetic field strength (B) surrounding the conductor, and also corresponding approximately to the motive force generated by the conductor when a certain electrical current is passed through it.

Magnetic circuit assemblies, such as those found in loudspeakers, may take various forms. For example, embodiments of magnetic circuit assemblies may include one or more features of those described generally above. It may be advantageous under certain circumstances to increase the amount of magnetic flux across a gap (e.g., the gap 204) by reducing magnetic reluctance in other areas of the magnetic circuit. This may be achieved in a number of ways. One way may include reducing or eliminating gaps (e.g., a glue gap or other interface layer) between separate components of the magnetic circuit, including, for example, gaps between magnet 152 components, front plate assembly 154 components, back plate 156 components, pole piece 158 components, and/or between any of the foregoing components. For example, it may be advantageous to provide separate first and second plates in the front plate assembly 154, each of which is directly secured to the magnet 152 (e.g., by glue). In some embodiments, the separate first and second front plates are forged and adhered to the magnet without machining, thus saving substantial manufacturing cost while eliminating gaps between front plate components and reducing magnetic losses.

FIG. 6 shows a schematic of a cross-section of an example magnetic circuit assembly 350. The magnetic circuit assembly 350 may include a first magnet 152; a front plate assembly 154 that includes a first plate 302, a second plate 304, a second magnet 306, and a top cap 308; and a yoke 360. The magnetic circuit assembly 350 may include other elements not shown and/or described elsewhere herein. The yoke 360 may be coupled to the first magnet 152 along a proximal surface of the magnet 152. The second plate 304 may be coupled to the first magnet 152 along a distal surface of the first magnet 152 and a proximal surface of the second plate 304. The first plate 302 may be coupled to the second plate 304 along a distal surface of the second plate 304 and a proximal surface of the first plate 302. The second magnet 306 may be coupled to the first plate 302 along a distal surface of the first plate 302 and a proximal surface of the second magnet 306. The top cap 308 may be coupled to the second magnet 306 along a distal surface of the second magnet 306 and a proximal surface of the top cap 308. The first plate 302 and/or second plate 304 may be manufactured (e.g., forged) separately and attached as shown. The first plate 302 and the second plate 304 may be manufactured as interchangeable parts. The first plate 302 and the second plate 304 may exhibit planar symmetry along a plane only in one rotational orientation. For example, as shown, rotation of the first plate 302 by 180 degrees about a vertical axis would not result in planar symmetry with the second plate 304 any longer. As an additional example, a 180-degree rotation of the first plate 302 about a horizontal axis may upset planar symmetry between the first plate 302 and the second plate 304, as shown.

As shown, in some embodiments each of the first plate 302 and the second plate 304 can have a respective first radial portion with a smaller axial dimension than a respective second radial portion. As shown, the second plate 304 has a first radial portion 304a and a second radial portion 304b. The first plate 302 can have similar radial portions (not labeled). In some embodiments the first radial portion 304a can be an inner radial portion relative to the second radial portion 304b (e.g., in FIG. 2). Alternatively, the first radial portion 304a can be an outer radial portion relative to the second radial portion 304b (e.g., in FIG. 4). A distance between the first plate 302 and the magnet 152 may be less than 0.5 mm. In some embodiments, the distance is about 0.1 mm and may be where adhesive is applied. The first plate 302 may be secured to the magnet 152 (e.g., adjacent the first region) along a proximal surface of the first plate 302. The first plate 302 may be secured to the magnet 152 using attachment means known in the art (e.g., adhesive, bonding, etc.). In some designs, a side surface 302c of the first plate 302 is radially coincident (e.g., equidistant from the central axis A) with a side surface 304c of the second plate 304. In some embodiments, a cross section of the first plate 302 forms an L-shape (e.g., an upside-down L). Additionally or alternatively, a cross section of the second plate 304 may form an L-shape. The first plate 302 and/or the second plate 304 may exhibit non-symmetry across a horizontal axis. Additionally or alternatively the first plate 302 and/or the second plate 304 may exhibit non-symmetry along a vertical axis. The first plate 302 may comprise a material with high magnetic permeability, such as steel (e.g., low carbon steel) and/or iron. Other materials with higher magnetic permeabilities are possible, such as composite materials.

A height (e.g., defined axially) of the side surface of the first plate 302 may be determined, at least in part, by the material used in the first plate 302. For example, it may be advantageous to avoid magnetic saturation of the material in the first plate 302. However, a certain minimum saturation level may be preferred. For example, in some embodiments, one or more components of the magnetic circuit (e.g., the coil 104, the front plate assembly 154, etc.) can have a saturation level of between about 85 percent and 99 percent of a saturation point of the material of the one or more components. As an example, certain types of steel (e.g., low carbon steel) may have a magnetic saturation point of about 2 T. In this example, a saturation level greater than about 90 percent (e.g., 1.8 T) and/or between about 92.5 percent (e.g., 1.7 T) and 97.5 percent (e.g., 1.95 T) may be preferred. Saturation levels in these ranges may help to reduce the influence of a current going through the coil and/or a movement of the coil 104 while in the fixed magnetic field, thus reducing flux modulation. This may also reduce resulting distortions. Further, this may also reduce the influence of the material (e.g., steel) on the inductance of the coil, further reducing distortion.

The second plate 304 of the front plate assembly 154 may be disposed adjacent a distal surface of the magnet 152. A distance between the second plate 304 and the magnet 152 may be less than 0.5 mm. The first radial portion 304a and the second radial portion 304b may not overlap in some embodiments.

In some embodiments, a space axially separates the first plate 302 from the second plate 304 (e.g., they are not touching). The second plate 304 may be secured to the magnet 152 using attachment means known in the art (e.g., adhesive, bonding, etc.). A shorting ring 320 may be disposed within the space that axially separates the first plate 302 from the second plate 304. Additionally or alternatively the first plate 302 and the second plate 304 may be disposed adjacent one another along respective portions (e.g., radial portions) of each plate. This enables the shorting ring to be placed in a more advantageous location within the assembly relative to the rest position of the voice coil winding.

As shown in FIG. 6, at least a portion of each of the first plate 302 and the second plate 304 may be disposed between the magnet 152 and the second magnet 306 in some embodiments. In some designs, the first plate 302 is disposed between the magnet 152 and the second plate 304 along an axis parallel the axis A. The first plate 302 and second plate 304 may be substantially comprised of a ferromagnetic metal, such as iron or steel. A height (e.g., defined axially) of the side surface 304c may be determined, at least in part, by the material used in the second plate 304. For example, it may be advantageous to avoid magnetic saturation of the material in the second plate 304. However, as described herein, certain levels of magnetic saturation may be preferred.

The yoke 360 may have common features of the yoke assembly 160 described for FIGS. 1-2 above. The yoke 360 may form a U-shape. For example, a first leg of the yoke 360 that form a first part of the “U-shape” may be secured to a proximal surface of the magnet 152. A second leg of the yoke 360 that forms a second part of the “U-shape” may extend a greater axial distance than the first leg. As shown in FIG. 6, a first portion 330 of the second leg of the yoke 360 may be disposed opposite the magnet 152. A second portion 332 of the second leg of the yoke 360 may be disposed opposite the side surface 304c of the second plate 304, forming a first gap 312. A third portion 334 of the second leg of the yoke 360 may be opposite the side surface 302c of the first plate 302, forming a second gap 314. The second leg of the yoke 360 may be tapered axially, as shown in FIG. 6. For example, the third portion 334 of the yoke 360 may be narrower than the first portion 330 of the yoke 360. An extended surface 340 of the yoke 360 may be planar and/or parallel with the axis A. A height of the distal-most portion of the third portion 334 of the yoke 360 may be proximal to (e.g., below) a distal-most surface of the top cap 308 and/or a distal-most surface of the second magnet 306. As noted above, this arrangement may enhance magnetic flux through the air and/or through one or more parts of a frame (e.g., a frame of a speaker).

A coil 104 (not shown) may be included in the magnetic circuit assembly 350. The coil 104 may be wrapped around a bobbin 102. Other features of the coil 104 and/or bobbin 102 of the magnetic circuit assembly 350 may be as described above for FIGS. 1-2. The coil 104 may have a height 208 that extends within the first gap 312 and/or second gap 314. The coil 104 may be configured to be modulated within the first gap 312 and/or the second gap 314 during use, depending on the needs of the magnetic circuit (e.g., to produce modified sound). In some designs, the coil 104 extends from a level of a distal surface of the first plate 302 to a level of a proximal surface of the second plate 304. However, the coil 104 may be shorter (e.g., have a smaller height 208) than this.

As noted below, the tapered radial portions of the first plate 302 and the second plate 304 can enhance magnetic flux across the corresponding first gap 312 and second gap 314. In this way, a strength of the magnetic circuit can be enhanced. This may allow performance thresholds to be reached that have previously been unreachable for a similar form factor. For example, the magnetic circuit assembly 150 may allow for increased sound volume if included in a speaker assembly, such as those described herein.

As noted above, some embodiments of the magnetic circuit assembly 350 may include a shorting ring 320. The shorting ring 320 may be referred to as a Faraday loop or a shorted turn. The shorting ring 320 may comprise a metal (e.g., copper, aluminum) or other electrically conductive material. The shorting ring 320 may be configured to be a magnetic flux insulator, such that the shorting ring 320 does not conduct magnetic flux well. It may be advantageous to include one or more shorting rings (e.g., the shorting ring 320) in order to improve function of the magnetic circuit assembly 350 by, for example, reducing a rise in impedance as frequency increases. The shorting ring may also reduce the effect of the current flowing through the voice coil moving across a gap (e.g., the gap 204) in the permanent magnetic field. Additionally or alternatively, the shorting ring 320 may reduce effective inductance of the coil 104 (not shown) for one or more ranges of frequencies (e.g., higher frequencies). The effective frequency range may be influenced by how much the shorting ring reduces the inductance. For example, without being limited by theory, the more the inductance that is reduced, the lower the frequency range in which the shorting ring becomes effective. In some designs, a shorting ring (e.g., the shorting ring 320) is adjacent the yoke 360. However, one or more shorting rings can be disposed in numerous configurations. For example, a shorting ring 320 may be disposed between the first plate 302 and the magnet 152, between the first plate 302 and the second plate 304 (as shown), and/or adjacent or near a portion of the yoke 360. For example, a shorting ring 320 can be disposed adjacent or near the yoke 360 opposite the second plate 304, opposite the first plate 302, opposite the magnet 152, and/or at a trough of the yoke 360. In certain configurations (e.g., core magnet designs), a shorting ring is disposed radially inward of the coil 104. In some embodiments, a shorting ring may be replaced by an electrically shorted loop of conductive wire occupying the same space, or a loop of conductive wire connected to a selected or variable electrical resistance placed inside or outside the motor assembly and electrically in series with the loop of wire, providing an adjusted or variable effect of the shorting structure.

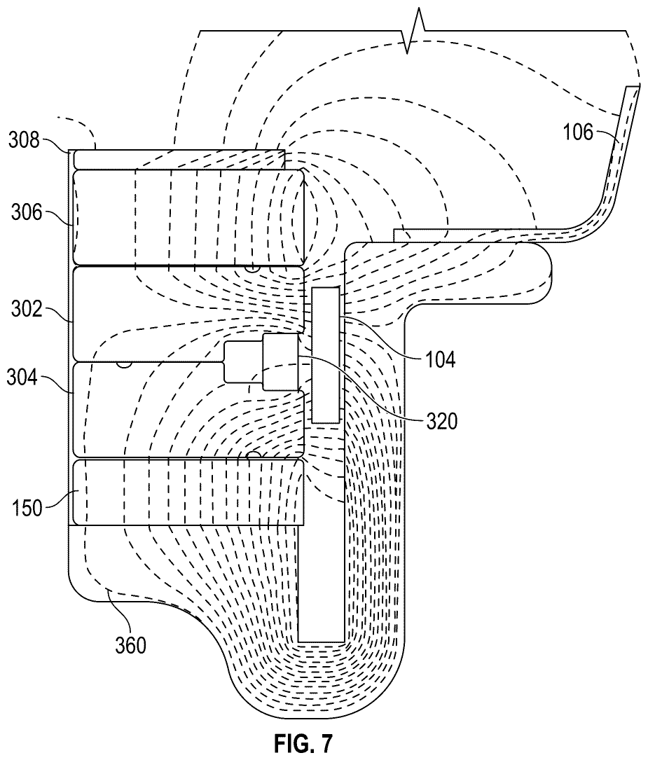

FIG. 7 shows another example magnetic circuit assembly 350, along with modeled magnetic field lines. As shown, the magnet 152 can be oriented to produce field lines exiting the magnet 152 parallel to the central axis A. The arrangement and shapes of the first plate 302, the second plate 304, and the yoke 360 can produce compact field lines across the first gap 312 and the second gap 314 (not shown here). In these gaps is where the coil 104 may be configured to translate. Such compact field lines can prevent substantial leakage of the magnetic field out of the magnetic circuit assembly. Designs using a plurality of plates in the front plate assembly, such as shown in FIG. 7, can promote more uniform magnetic field strength across a region in which the coil 104 is disposed than other designs. FIG. 7 shows a shorting ring 320 disposed between the first plate 302 and the second plate 304. The shorting ring 320 may be adjacent one or both of the first plate 302 and/or second plate 304. For example, the shorting ring 320 may be adhered to one or both of them, or mechanically captured between both. Providing separate plates 302, 304 can better allow the placement of a shorting ring 320 between the plates, thus providing additional benefit of the designs described herein.

FIG. 8 shows a graph of values for the product (BL product, in Tm) of magnetic field strength (B, in T) over a distance (L, in m) along an example voice coil of various magnetic circuits described with regard to FIG. 7 (in mm). The voice coil may be, for example, the coil 104. Generally, it can be advantageous to approximate a constant (or “flat”) BL value across a greater length of the voice coil position relative to a resting position of the voice coil. As shown, the BL value of is flat, for example, from −5.0 mm to 10.0 mm. This can result in improved sound quality compared to a loudspeaker with a larger slope within the domain of −5.0 mm to 10.0 mm and increases the linearity of the response of the coil 104 to an input signal. For example, this can reduce harmonic distortions. FIG. 8 also shows values for magnetic field strength (B, in T) along an example voice coil of various magnetic circuits described with regard to FIG. 7 (in mm). Generally, it can be advantageous to approximate a symmetric B value across relative to a center of the voice coil. As shown, the B value of the design shown in FIG. 7 is fairly symmetrical across the distances shown. This can improve the predictability and consistency of the sound produced from a given input.

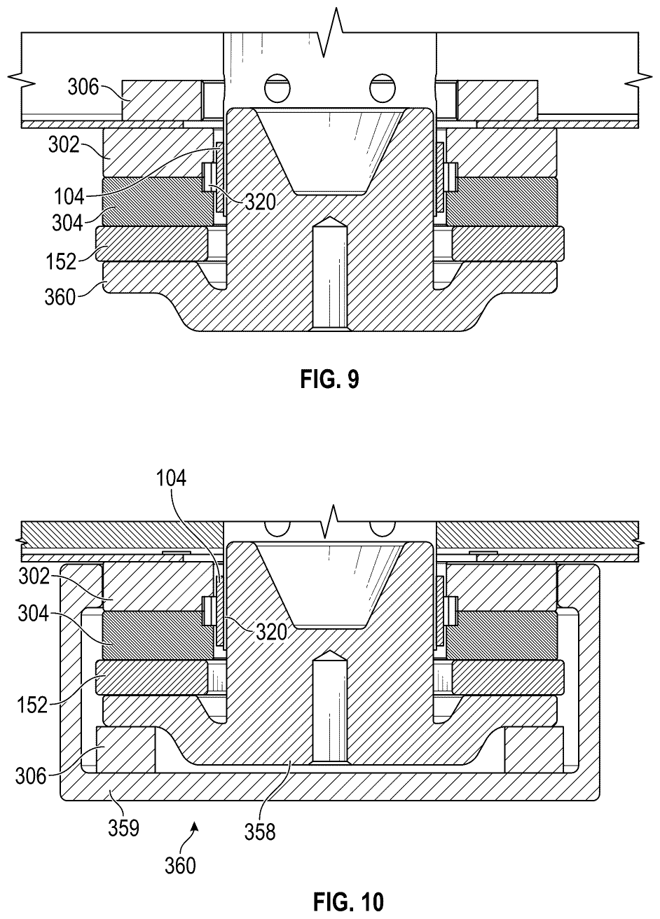

FIG. 9 shows a schematic of a cross section of another example embodiment of a ring magnet design of a loudspeaker, according to some embodiments. As shown in FIG. 9, the magnetic circuit assembly may include a first plate 302 and a second plate 304 below (e.g., proximal to) a ferromagnetic metal frame of the loudspeaker. As shown, the first magnet 152 can be disposed along a surface of the yoke 360, and the second plate 304 can be disposed along a surface of the first magnet 152. The first plate 302 and the second plate 304 may be disposed such that a distal-most surface of the yoke 360 is more distal than a distal-most surface of the first plate 302 in order to produce a symmetrical magnetic field distribution between the two magnetic gaps. A distal surface of the distal-most plate interfaces with a proximal surface of the ferromagnetic frame of the speaker, forming part of the magnetic circuit. A second magnet 306 interfaces at its proximal side with the ferromagnetic frame of the speaker, with the air at the distal side, forming an air return path for the second magnet 306. Thus, in some embodiments, the ferromagnetic member of the frame can be “sandwiched” between the second magnet 306 and the first plate 302. In some embodiments, a top cap 308 is included along a distal surface of the second magnet 306. However, a top cap may not be present in certain embodiments.

FIG. 10 shows a schematic of a cross section of an example embodiment of a ring magnet design of a loudspeaker, according to some embodiments. The embodiment shown in FIG. 10 can include many features included in FIG. 9. FIG. 10 includes a second magnet 306 that is proximal to (e.g., below) a portion of the yoke 360 and above a different portion of the yoke 360. As shown, the second magnet 306 is disposed between a pole piece of a first magnetic yoke 358 and an inner surface of a second magnetic yoke 359. The first magnetic yoke 358 may form a U-shape. The second magnetic yoke 359 may serve as a magnetic path around one or more of the other elements in the magnetic circuit assembly. For example, the second yoke 359 may couple to the first plate 302 and/or to the second magnet 306, as shown. The second magnetic yoke 359 can serve as shielding to capture lost flux, thus improving magnetic efficiency. This shielding effect can reduce the interaction between the magnetic field and certain types of sensitive equipment. The first magnet 152 can help provide additional flux to the front plate assembly in a reinforcing direction, increasing available flux in the magnetic circuit. The second magnet 306 may include one or more features of the second magnet 306 described above in other embodiments.

### Example Embodiments

Clause 1. A magnetic circuit for inclusion in a loudspeaker, the magnetic circuit comprising: a first plate having a distal surface and a proximal surface; a second plate having a distal surface and a proximal surface opposite the distal surface, the distal surface of the second plate disposed along the proximal surface of the first plate, at least one of the first or the second plates having a first radial portion with a smaller axial dimension than a second radial portion; a magnet having a distal surface and a proximal surface, the distal surface of the magnet disposed along the proximal surface of the second plate; and a yoke disposed along the proximal surface of the magnet, the yoke shaped to form first and second magnetic circuit gaps radially between the yoke and the first and second plates, respectively.

Clause 2. The magnetic circuit of Clause 1, wherein the yoke forms a U-shape.

Clause 3. The magnetic circuit of Clause 1, wherein the first and second magnetic circuit gaps are sized to receive a voice coil therein.

Clause 4. The magnetic circuit of Clause 3, wherein the first radial portion forms an axial gap with another of the first or second plates.

Clause 5. The magnetic circuit of Clause 4, wherein the axial gap is configured to receive a shorting ring therein.

Clause 6. The magnetic circuit of Clause 1, wherein the magnet comprises a ring magnet.

Clause 7. The magnetic circuit of Clause 1, wherein the magnet is configured to generate a higher magnetic flux than ferrite.

Clause 8. The magnetic circuit of Clause 1, wherein the magnet comprises neodymium.

Clause 9. The magnetic circuit of Clause 1, further comprising a second magnet having a proximal surface disposed along the distal surface of the first plate.

Clause 10. The magnetic circuit of Clause 9, further comprising a second magnet having a distal surface disposed distally beyond a most distal surface of the yoke.

Clause 11. The magnetic circuit of Clause 1, further comprising a frame coupled to a distal end of the yoke, wherein the first magnet is disposed relative to the yoke such that magnetic field flux from the magnet is configured to substantially pass through the frame.

Clause 12. The magnetic circuit of Clause 1, wherein each of the first and the second plates has a respective first radial portion with a smaller axial dimension than a respective second radial portion.

Clause 13. The magnetic circuit of Clause 1, wherein the first radial portion is nearer the first magnetic gap than is the second radial portion.

Clause 14. A speaker comprising: a magnetic circuit comprising: a first magnet having a distal surface and a proximal surface; a first plate having a distal surface and a proximal surface, the distal surface of the first plate disposed along the proximal surface of the first magnet; a second plate having a distal surface and a proximal surface, the distal surface of the second plate disposed along the proximal surface of the first plate; a second magnet having a distal surface and a proximal surface, the distal surface of the second magnet disposed along the proximal surface of the second plate; and a yoke disposed along the proximal surface of the second magnet, the yoke shaped to form first and second magnetic circuit gaps radially between the yoke and the first and second plates, respectively; wherein the distal surface of the first magnet is disposed distally beyond a most distal surface of the yoke; a voice coil configured to be disposed between at least the first and second magnetic circuit gaps; a diaphragm engaged with the voice coil; and a frame configured to support the diaphragm and to be operatively coupled to the yoke.

Clause 15. The speaker of Clause 14, wherein an outer radial portion of the first plate has a smaller axial dimension than an inner radial portion of the first plate, and wherein an outer radial portion of the second plate has a smaller axial dimension than an inner radial portion of the second plate.

Clause 16. The speaker of Clause 15, wherein the inner radial portions of the first and second plates form an axial gap.

Clause 17. The speaker of Clause 16, wherein the axial gap is configured to receive a shorting ring therein.

Clause 18. The speaker of Clause 14, wherein the first magnet is disposed relative to the yoke such that the frame is configured to conduct magnetic field flux from the first magnet.

Clause 19. A speaker comprising: a magnetic circuit comprising: a first plate and a second plate each disposed between a first magnet and a second magnet, at least one of the first or second plates exhibiting non-symmetry across a horizontal axis; and a yoke disposed along the second magnet, the yoke shaped to form first and second magnetic circuit gaps radially between the yoke and the first and second plates, respectively; a voice coil configured to be disposed between at least the first and second magnetic circuit gaps; a diaphragm engaged with the voice coil; and a frame configured to support the diaphragm, wherein the first magnet is disposed relative to the yoke such that the frame is configured to conduct magnetic field flux from the first magnet.

Clause 20. The speaker of Clause 19, wherein an outer radial portion of the first plate has a smaller axial dimension than an inner radial portion of the first plate, and wherein an outer radial portion of the second plate has a smaller axial dimension than an inner radial portion of the second plate.

Clause 21. The speaker of Clause 20, wherein the inner radial portions of the first and second plates form an axial gap.

Clause 22. The speaker of Clause 21, wherein the axial gap is configured to receive a shorting ring therein.

Clause 23. The speaker of Clause 21, wherein at least one of the first or second magnets comprises neodymium.

### CONCLUSION

Reference throughout this specification to “some embodiments” or “an embodiment” means that a particular feature, structure or characteristic described in connection with the embodiment is included in at least some embodiments. Thus, appearances of the phrases “in some embodiments” or “in an embodiment” in various places throughout this specification are not necessarily all referring to the same embodiment and may refer to one or more of the same or different embodiments. Furthermore, the particular features, structures or characteristics may be combined in any suitable manner, as would be apparent to one of ordinary skill in the art from this disclosure, in one or more embodiments.

As used in this application, the terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Similarly, it should be appreciated that in the above description of embodiments, various features are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that any claim require more features than are expressly recited in that claim. Rather, inventive aspects lie in a combination of fewer than all features of any single foregoing disclosed embodiment. Accordingly, no feature or group of features is necessary or indispensable to each embodiment.

A number of applications, publications, and external documents may be incorporated by reference herein. Any conflict or contradiction between a statement in the body text of this specification and a statement in any of the incorporated documents is to be resolved in favor of the statement in the body text.

Although described in the illustrative context of certain preferred embodiments and examples, it will be understood by those skilled in the art that the disclosure extends beyond the specifically described embodiments to other alternative embodiments and/or uses and obvious modifications and equivalents. Thus, it is intended that the scope of the claims which follow should not be limited by the particular embodiments described above.

What is claimed is:

1. A magnetic circuit for inclusion in a loudspeaker, the magnetic circuit comprising:
a first plate having a distal surface and a proximal surface;
a second plate having a distal surface and a proximal surface opposite the distal surface, the distal surface of the second plate disposed along the proximal surface of the first plate, at least one of the first or the second plates having a first radial portion with a smaller axial dimension than a second radial portion;
a magnet having a distal surface and a proximal surface, the distal surface of the magnet disposed along the proximal surface of the second plate;
a second magnet configured to increase magnetic flux within the magnetic circuit; and
a yoke disposed along the proximal surface of the magnet, the yoke shaped to form first and second magnetic circuit gaps radially between the yoke and the first and second plates, respectively.

2. The magnetic circuit of claim 1, wherein the yoke forms a U-shape.

3. The magnetic circuit of claim 1, wherein the first and second magnetic circuit gaps are sized to receive a voice coil therein.

4. The magnetic circuit of claim 3, wherein the first radial portion forms an axial gap with another of the first or second plates.

5. The magnetic circuit of claim 4, wherein the axial gap is configured to receive a shorting ring therein.

6. The magnetic circuit of claim 1, wherein the magnet comprises a ring magnet.

7. The magnetic circuit of claim 1, wherein the magnet is configured to generate a higher magnetic flux than ferrite.

8. The magnetic circuit of claim 1, wherein the magnet comprises neodymium.

9. The magnetic circuit of claim 1, wherein the second magnet comprises a proximal surface disposed along the distal surface of the first plate.

10. The magnetic circuit of claim 9, wherein the second magnet comprises a distal surface disposed distally beyond a most distal surface of the yoke.

11. The magnetic circuit of claim 1, further comprising a frame coupled to a distal end of the yoke, wherein the first magnet is disposed relative to the yoke such that magnetic field flux from the magnet is configured to substantially pass through the frame.

12. The magnetic circuit of claim 1, wherein each of the first and the second plates has a respective first radial portion with a smaller axial dimension than a respective second radial portion.

13. The magnetic circuit of claim 1, wherein the first radial portion is nearer the first magnetic gap than is the second radial portion.

14. A speaker comprising:
a magnetic circuit comprising:
a first magnet having a distal surface and a proximal surface;
a first plate having a distal surface and a proximal surface, the distal surface of the first plate disposed along the proximal surface of the first magnet;
a second plate having a distal surface and a proximal surface, the distal surface of the second plate disposed along the proximal surface of the first plate;
a second magnet having a distal surface and a proximal surface, the distal surface of the second magnet disposed along the proximal surface of the second plate; and
a yoke disposed along the proximal surface of the second magnet, the yoke shaped to form first and second magnetic circuit gaps radially between the yoke and the first and second plates, respectively;
wherein the distal surface of the first magnet is disposed distally beyond a most distal surface of the yoke;
a voice coil configured to be disposed between at least the first and second magnetic circuit gaps;
a diaphragm engaged with the voice coil; and
a frame configured to support the diaphragm and to be operatively coupled to the yoke.

15. The speaker of claim 14, wherein an outer radial portion of the first plate has a smaller axial dimension than an inner radial portion of the first plate, and wherein an outer radial portion of the second plate has a smaller axial dimension than an inner radial portion of the second plate.

16. The speaker of claim 15, wherein the inner radial portions of the first and second plates form an axial gap.

17. The speaker of claim 16, wherein the axial gap is configured to receive a shorting ring therein.

18. The speaker of claim 14, wherein the first magnet is disposed relative to the yoke such that the frame is configured to conduct magnetic field flux from the first magnet.

19. A speaker comprising:
a magnetic circuit comprising:
a first plate and a second plate each disposed between a first magnet and a second magnet, at least one of the first or second plates exhibiting non-symmetry across a horizontal axis; and
a yoke disposed along the second magnet, the yoke shaped to form first and second magnetic circuit gaps radially between the yoke and the first and second plates, respectively;
a voice coil configured to be disposed between at least the first and second magnetic circuit gaps;
a diaphragm engaged with the voice coil; and
a frame configured to support the diaphragm, wherein the first magnet is disposed relative to the yoke such that the frame is configured to conduct magnetic field flux from the first magnet.

20. The speaker of claim 19, wherein an outer radial portion of the first plate has a smaller axial dimension than an inner radial portion of the first plate, and wherein an outer radial portion of the second plate has a smaller axial dimension than an inner radial portion of the second plate.
